(19) United States
(12) Patent Application Publication
(10) Pub. No.: US 2023/0241908 A1
(43) Pub. Date: Aug. 3, 2023

(54) APPARATUSES FOR MOUNTING CONTROL PANELS IN PRINTING DEVICES

(71) Applicant: Hewlett-Packard Development Company, L.P., Spring, TX (US)

(72) Inventor: Clinton Troy Jensen, Boise, ID (US)

(73) Assignee: Hewlett-Packard Development Company, L.P., Spring, TX (US)

(21) Appl. No.: 17/589,551

(22) Filed: Jan. 31, 2022

(51) Int. Cl. B41J 29/393; B41J 29/02; B41J 29/04

(52) U.S. Cl. CPC B41J 29/393; B41J 29/02; B41J 29/04

(57) ABSTRACT

According to examples, an apparatus may include a base to be attached to a chassis of a printing device. The apparatus may also include a first link rotatably mounted to the base at a first section of the first link and a second link rotatably mounted to the first link at a second section of the first link, in which the second link may be movably mounted to a movable lid assembly of the printing device at a first section of the second link. The apparatus may further include a control panel mount attached to the second link at the second section of the second link.

### BACKGROUND

Printing devices, such as laser printers, laser multi-function printing devices, etc., typically use a printer cartridge that contains a recording material such as toner to record an image on a medium such as paper. Some compact printing devices may include a lid assembly that may be positioned over a cover of a bay into which the printer cartridge is installed. In these types of printing devices, the lid assembly may be moved to enable access to the cover and thus the printer cartridge bay within the printing devices.

### BRIEF DESCRIPTION OF DRAWINGS

Features of the present disclosure are illustrated by way of example and not limited in the following figure(s), in which like numerals indicate like elements, in which:

FIG. 1 shows a block diagram of an example apparatus for supporting a control panel of a printing device;

FIGS. 2A and 2B respectively show perspective views of an example printing device including the example apparatus depicted in FIG. 1, a chassis, and a lid assembly; and

FIG. 3 shows a side view of the example printing device depicted in FIG. 2B.

### DETAILED DESCRIPTION

For simplicity and illustrative purposes, the principles of the present disclosure are described by referring mainly to examples thereof. In the following description, numerous specific details are set forth in order to provide an understanding of the examples. It will be apparent, however, to one of ordinary skill in the art, that the examples may be practiced without limitation to these specific details. In some instances, well known methods and/or structures have not been described in detail so as not to unnecessarily obscure the description of the examples. Furthermore, the examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on.

Some types of printing devices, such as desktop or other types of relatively compact printing devices, may include lid assemblies that are mounted to the chassis of the printing devices. The lid assemblies may be positioned above the chassis and may include various components of the printing devices. For instance, the lid assemblies may include automatic document feeders, scanner assemblies, input trays, sensors, and/or the like.

In many of these types of printing devices, the lid assemblies may be movable between a first position at which the lid assemblies are in position to receive documents and a second position at which the lid assemblies are not in a position to receive documents. The first position may be a position in which the lid assemblies are directly on top of the chassis of the printing devices. When the lid assemblies are in the first position, the lid assemblies may, for instance, be in a position to receive and scan documents. The second position may be a position in which the lid assemblies are rotated away from the chassis such that components of the printing devices may be accessible. For instance, an interior of the chassis may be accessible when the lid assemblies are in the second position.

In some instances, the lid assemblies may be rotated from the first position to the second position when a toner cartridge is to be inserted or replaced. In addition, or in other instances, the lid assemblies may be rotated from the first position to the second position when a paper jam occurs and a user attempts to clear the paper jam.

The lid assemblies may also include control panels that are mounted on the lid assemblies such that the control panels may move with the lid assemblies. The control panels may provide, for instance, a graphical interface through which users may be provided with graphical information. The control panels may also provide the graphical interface to enable the users to interact with the printing devices, for instance, through touch input. As the control panels are mounted to the lid assemblies, when the lid assemblies are moved to the second position, the viewing angles of the control panels may similarly be moved. As a result, users may be unable to comfortably view the control panels when the lid assemblies are in the second position. This may be an issue, for instance, when instructions for the users are provided on the control panel to clear a paper jam or perform some other functions while the lid assemblies are in the second position. In these instances, users may adjust the control panel such the users may more comfortably view the control panels. In addition, when the users move the lid assemblies back to the first position, the users may adjust the control panel again to comfortably view the control panels.

Additionally, data and power cables for the control panels may extend along the widths of the lid assemblies in order for the cables to be hidden from view when the lid assemblies are in the second position. This may cause the cables to be relatively long, which may increase costs associated with fabricating the printing devices.

Disclosed herein are apparatuses, e.g., movable control panel systems, for supporting control panels in printing devices. Also discussed herein are printing devices including the apparatuses. The apparatuses disclosed herein may include a base to be attached to a chassis of a printing device and a first link rotatably mounted to the base at a first section of the first link. The apparatuses may also include a second link rotatably mounted to the first link at a second section of the first link. The second link is to be movably mounted to a movable lid assembly of the printing device at a first section of the second link. The apparatuses may further include a control panel mount attached to the second link at the second section of the second link.

As discussed herein, the first link and the second link may be mounted to the printing device in a manner that enables a control panel mounted to the control panel mount to substantially maintain a constant viewing angle regardless of whether the lid assembly is in a closed position or in an open position with respect to the chassis of the printing device. As a result, a user of the printing device may not need to re-position the control panel to comfortably view the control panel when the lid assembly is in the open position. In addition, the first link and the second link may enable power and data cables to be run between the control panel and electronics within the chassis of the printing device. In this regard, lengths of the cables may significantly be reduced as compared with printing devices in which the cables are run along the widths of the lid assemblies.

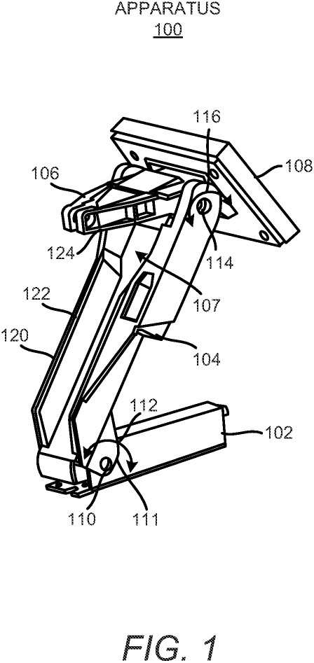

Reference is first made to FIG. 1, which shows a block diagram of an example apparatus 100 for mounting a control panel to a printing device. It should be understood that the example apparatus 100 may include additional features and that some of the features described herein may be removed and/or modified without departing from the scope of the apparatus 100.

As shown in FIG. 1, the apparatus 100, which may also be termed a movable control panel system herein, may include a base 102, a first link 104, a second link 106, and a control panel mount 108. As discussed herein, the base 102 may be mounted to a chassis of a printing device. The base 102 may also be referenced as a lift of a linkage system herein. In some examples, the base 102 may be mounted to the chassis such that the base 102 may be immovable with respect to the chassis. For instance, the base 102 may be mounted to the chassis through use of mechanical fasteners, welds, adhesives, and/or the like. In other examples, the base 102 may be mounted to the chassis such that the base 102 may be movable with respect to the chassis. For instance, the base 102 may be mounted to the chassis via a pin and slot configuration, a slider configuration, and/or the like.

The first link 104 may be rotatably mounted to the base 102 at a first pivot location 110. For instance, the base 102 and the first link 104 may each include an opening through which a pin may be inserted. As another example, the base 102 may include an opening into which a tab on the first link 104 may be inserted. As a further example, the base 102 may include a tab that may be inserted into an opening in the first link 104. The first link 104 may be rotatably mounted to the base 102 in any other suitable manner. In any of these examples, the first link 104 may rotate with respect to the base 102 as indicated by the arrow 112.

In some examples, the base 102 may extend in a direction parallel to a front to a rear of the chassis. In addition, the base 102 may be rotatably mounted to a rear portion of the base 102. Moreover, the first link 104 may be mounted to the rear portion of the base 102 at a proximal end of the first link 1 04. The first link 104 may further be rotatably mounted to the base 102 such that a bottom surface of the first link 104 may be relatively flush with an upper surface of the base 102 when the first link 104 is in a first position corresponding to a closed position of a lid assembly of a printing device. For instance, the first pivot location 110 may be located on a tab 111 that extends below the bottom surface of the first link 104.

The first link 104 may also be rotatably mounted to the second link 106 at a distal end of the first link 104. The first link 104 may be mounted to the second link 106 at a second pivot location 114. For instance, the first link 104 and the second link 106 may each include an opening through which a pin may be inserted. As another example, the first link 104 may include an opening into which a tab on the second link 106 may be inserted. As a further example, the second link 106 may include a tab that may be inserted into an opening in the first link 104. The first link 104 may be rotatably mounted to the second link 106 in any other suitable manner. In any of these examples, the second link 106 may rotate with respect to the first link 104 as indicated by the arrow 116.

As shown, the second link 106 may be mounted to the first link 104 at a proximal end section of the second link 106. The first link 104 may include a recess 107 into which the second link 106 may be inserted. For instance, the recess 107 may be shaped similarly to the second link 106 such that at least a portion of the second link 106 may be inserted into the recess 107 when the first link 104 and the second link 106 are in positions corresponding to a closed position of the lid assembly of the printing device.

Additionally, the control panel mount 108 may be attached to the proximal end section of the second link 106. In some examples, the control panel mount 108 may rotatably be mounted to the second link 106. For instance, the control panel mount 108 may rotate between a relatively small range of angles, such as about 15 to 20 degrees. As the control panel mount 108 is mounted to the end of the second link 106, the angle of the control panel mount 108 may change as the angle of the second link 106 changes.

As discussed in further detail below, the second link 106 at a distal end section thereof may be movably mounted to a lid assembly of the printing device. Particularly, for instance, a bracket may be mounted to the lid assembly, in which the bracket may include a slot. In this example, a pin attached at the distal end section of the second link 106 may be inserted in the slot. As a result, as the lid assembly is moved, the pin may also move within the slot causing the second link 106 to move along with the lid assembly. In other examples, the distal end section of the second link 106 may be attached to the lid assembly in other manners while enabling the linear movement of the distal end section of the second link 106 with respect to the lid assembly.

According to examples, the apparatus 100 may be formed of materials that may provide sufficient strength to the apparatus 100 to enable the apparatus 100 to support the lid assembly. For instance, the apparatus 100 may be formed of a suitable plastic material or materials, a suitable metallic material or materials, combinations thereof, or the like. In addition, the first link 104 and the second link 106 may include structural features, such as ribs 120-124, to provide structural support to the first link 104 and the second link 106 while enabling the first link 104 and the second link 106 to have relatively thin profiles.

According to examples, the lid assembly is movable between an open position and a closed position with respect to the chassis of the printing device. In addition, the control panel mount 108 may maintain a substantially constant angle as the lid assembly is moved between the open position and the closed position. The substantially constant angle may include a range of angles that are between about 0° and about 5°. In other examples, the substantially constant angle may include a range of angles that are between about 2° and about 10°. In still other examples, the substantially constant angle may include other ranges of angles.

The control panel mount 108 may maintain the substantially constant angle as a result of the configuration of the connection between the second link 106 and the first link 104 and the manner in which the control panel mount 108 is mounted to the second link 106. The configuration of the connection between the second link 106 and the lid assembly may also cause the control panel mount 108 to maintain the substantially constant angle. That is, for instance, as the second link 106 may be relatively shorter than the first link 104, the second link 106 may undergo a relatively shorter range of angular motion than the first link 104 during movement of the lid assembly. In addition, the linear movement of the distal end of the second link 106 with respect to the lid assembly may prevent the angle of the second link 106 from undergoing a large range of motion during rotational movement of the lid assembly.

In some examples, a damper (not shown) may be positioned at the connection between the second link 106 and the first link 104, for instance, at the second pivot location 114. The damper may, for instance, be a friction gear damper that may dampen rotation between the first link 104 and the second link 106. The damper may be housed within an opening inside the second link 106 and may thus be hidden from view in FIG. 1. The damper may alternatively be positioned outside of the first link 104 and the second link 106.

Generally speaking, the damper may provide resistance during movement of the lid assembly. For instance, the damper may provide a force to bias the lid assembly in an upward direction to prevent the lid assembly from falling when the lid assembly is in the open position. In addition, the damper may hold the lid assembly in positions between the open and closed positions. The damper may also make movement of the lid assembly have a more natural feel to a user. In some examples, another damper may be provide at a hinge location between the chassis and the lid assembly of the printing device to further support the lid assembly.

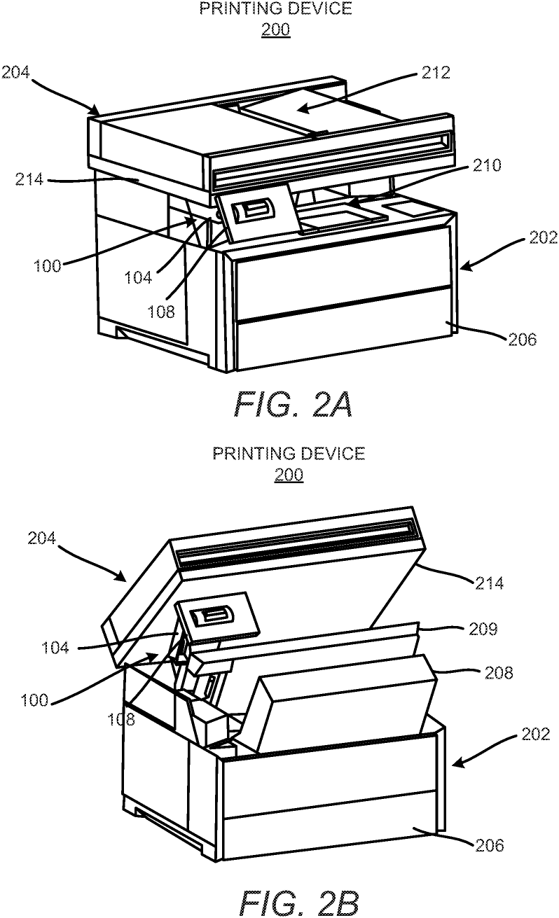

Reference is now made to FIGS. 2A and 2B, which respectively show perspective views of an example printing device 200 including the example apparatus 100 depicted in FIG. 1, a chassis 202, and a lid assembly 204. Particularly, FIG. 2A shows the lid assembly 204 of the printing device 200 in a closed position and FIG. 2B shows the lid assembly 204 in an open position. It should be understood that the example printing device 200 may include additional features and that some of the features described herein may be removed and/or modified without departing from the scope of the printing device 200.

Generally speaking, the printing device 200 may be a multi-function printing device. In this regard, the printing device 200 may perform any of printing operations, scanning operations, faxing operations, and/or the like. In addition, the chassis 202 of the printing device 200 may house or otherwise include a number of components to perform these operations. For instance, the chassis 202 of the printing device 200 may house a media tray 206 that may hold sheets of media upon which images may be printed. The media tray 206 may be removable from the chassis 202 to enable additional sheets of media to be inserted into the media tray 206.

The chassis 202 may also house various picking mechanisms, motors, sensors, and/or the like to move sheets of media from the media tray 206 to a print zone within the chassis 202. The print zone may include an area in which toner from a toner cartridge 208 may selectively be applied onto the sheets of media, for instance, through use of laser beams, an imaging unit, a fuser unit, etc. Following printing of images onto the sheets of media, the sheets of media may be outputted to an output location 210, e.g., an output tray, of the printing device 200.

As shown in FIG. 2A, the lid assembly 204 may include an automatic document feeder 212. During operation, a user may place a stack of media sheets to be copied, scanned, faxed, or a combination thereof, into the automatic document feeder 212. The automatic document feeder 212 may feed the media sheets one by one over a scanner (not shown). The lid assembly 204 may also include a scanning bed 214 that is positioned beneath the automatic document feeder 212, which may include the scanner. In some examples, the automatic document feeder 212 may be rotated away from the scanning bed 214 to enable the scanning bed 214 to be exposed. A user may place a sheet of media on the scanning bed 214 while the scanning bed 214 is exposed.

As shown in FIGS. 2A and 2B, the apparatus 100, which may also be termed a lift apparatus 100 herein, may be integrated into the printing device 200. In this regard, the majority of the portions of the apparatus 100 may be hidden from view when the lid assembly 204 is in a closed position with respect to the chassis 202. That is, the chassis 202 may include a cover 209 that may block access to the interior of the chassis 202. In the example shown in FIG. 2A, a portion of the first link 104 and the control panel mount 108 may be visible when the lid assembly 204 is in the closed position. However, when the lid assembly 204 is moved to the open position as shown in FIG. 2A, the first link 104 and the second link 106 of the apparatus 100 may be visible.

As also shown in FIG. 2A, a rear section of the lid assembly 204 may be supported on a rear section of the chassis 202 such that a front section of the lid assembly 204 may be rotated away from the top of the chassis 202. During movement, or rotation, of the lid assembly 204 from the closed position to the open position, the distal end of the first link 104 may rotate away from the base 102. In addition, the distal end of the second link 106 may rotate away from the first link 104. The first link 104 and the second link 106 may be rotated as shown in FIG. 1.

According to examples, the lid assembly 204 may be moved to the open position as shown in FIG. 2B to enable access to an interior of the chassis 202. For instance, while the lid assembly 204 is in the open position, a user may open the cover 209 of the chassis 202 as also shown in FIG. 2B. The user may open the cover 209 to remove a toner cartridge 208 from a toner cartridge receptacle inside the chassis 202 or to insert the toner cartridge 208 into the toner cartridge receptacle. The user may also or alternatively open the cover 209 to clear a media jam within the chassis 202. The user may also open the cover 209 to access, replace, and/or fix other components within the chassis 202.

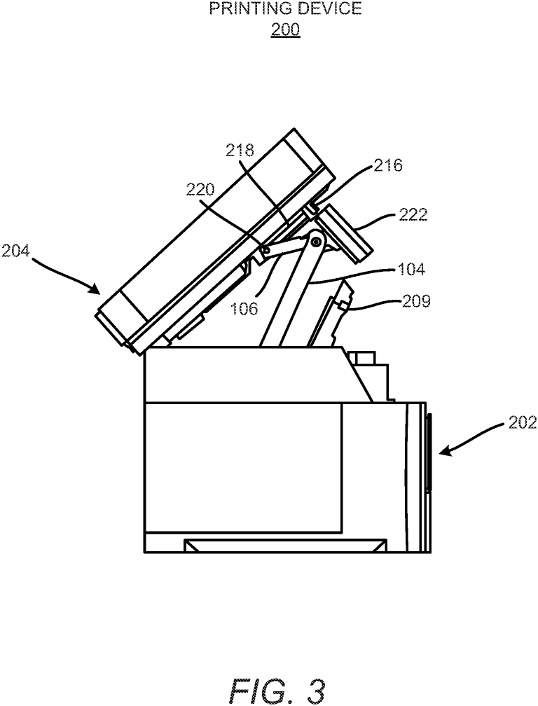

Turning now to FIG. 3, there is shown a side view of the example printing device 200 depicted in FIG. 2B. Particularly, the lid assembly 204 is depicted as being in the open position such that the first link 104 and the second link 106 are both in extended positions. In addition, the lid assembly 204 is depicted as including a bracket 216 having a slot 218. The bracket 216 may be fixedly mounted to a bottom side of the lid assembly 204. In addition, a pin 220 may be provided to extend through the distal section of the second link 106 and the slot 218. As a result, the pin 220 may move from one side of the slot to the other as the lid assembly 204 is moved between the open and closed positions.

In some examples, the linear movement of the pin 220 within the slot 218 may cause rotation of the second link 106 to substantially be minimized regardless of the position of the lid assembly with respect to the chassis 202. That is, the second link 106 may undergo a relatively minor level of angular change between when the lid assembly 204 is in the closed position and the open position. For instance, the second link 106 may undergo less than about a 10° change, less than about a 5° change, or the like.

As the control panel mount 108 may be mounted to an end of the second link 106, the control panel mount 108 may also undergo the relatively minor level of angular change when the lid assembly 204 is moved from the closed position to the open position and vice versa. In this regard, a viewing angle of a control panel 222 mounted to the control panel mount 108 may remain substantially constant prior to, during, and after movement of the lid assembly 204 from the closed position to the open position. Thus, for instance, a user may comfortably view information displayed on the control panel 222 while the lid assembly 204 is in either of the closed and open positions. The control panel 222 may be mounted to the control panel mount 108 in any suitable manner such as, through use of mechanical fasteners, mating structural features, adhesives, and/or the like. In some examples, the control panel 222 may be removably mounted to the control panel mount 108.

In some examples, instructions may be provided on the control panel 222 to guide a user as to how to clear a media jam inside of the chassis 202. In some examples, other types of instructions may be provided on the control panel 222, such as instructions as to how to remove and replace a toner cartridge or other component within the chassis 202. In any of these examples, the control panel 222 may display a set of instructions while the lid assembly 204 is in the closed position. Following movement of the lid assembly 204, the control panel 222 may continue to display the instructions or display another set of instructions, for instance, for the user to open the cover 209, remove the toner cartridge 208, and/or the like. As the angle of the control panel 222 may remain substantially constant while the lid assembly 204 is in the closed position and the open position as discussed herein, the user may view the instructions displayed on the control panel 222 without rotating the control panel 222 or rotating the control panel 222 slightly.

According to examples, power and data cables (not shown) may be directed to the control panel from an interior of the chassis through the apparatus 100. For instance, the first link 104 may include a channel (not shown) through which the power and data cables may be run. By running the cables through the apparatus 100, the lengths of the cables may be shortened compared to cables that are run along the width of the lid assembly 204.

Although described specifically throughout the entirety of the instant disclosure, representative examples of the present disclosure have utility over a \wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims -- and their equivalents -- in which all terms are meant in their broadest reasonable sense unless otherwise indicated.

What is claimed is:

1. An apparatus comprising:
a base to be attached to a chassis of a printing device;
a first link rotatably mounted to the base at a first section of the first link;
a second link rotatably mounted to the first link at a second section of the first link, wherein the second link is to be movably mounted to a movable lid assembly of the printing device at a first section of the second link; and
a control panel mount attached to the second link at the second section of the second link.

2. The apparatus of claim 1, wherein the control panel mount is rotatably attached to the second link.

3. The apparatus of claim 2, wherein the movable lid assembly is movable between an open position and a closed position with respect to the chassis of the printing device, and wherein the control panel mount is to maintain a substantially constant angle as the movable lid assembly is moved between the open position and the closed position.

4. The apparatus of claim 1, further comprising:
a damper at a connection between the first link and the second link, wherein the damper is to dampen rotation between the first link and the second link.

5. The apparatus of claim 1, wherein the second section of the second link includes a pin and wherein the pin is to be linearly movable within a groove of a bracket attached to the movable lid assembly of the printing device.

6. The apparatus of claim 1, wherein the first section of the first link is proximal to the base and the second section of the first link is distal to the base.

7. The apparatus of claim 1, wherein the second link is shorter than the first link and wherein the first link includes a recess into which the second link is insertable.

8. A printing device comprising:
a chassis;
a lid assembly rotatable between an open position and a closed position with respect to the chassis; and
a lift apparatus to support the lid assembly in the open position, the lift apparatus comprising:
a base attached to the chassis;
a first link rotatably mounted to the base;
a second link rotatably mounted to the first link and movably connected to the lid assembly; and
a control panel mount attached to the second link, wherein the first link and the second link are to move between various positions during movement of the lid assembly between the open and closed positions.

9. The printing device of claim 8, further comprising:
a control panel mounted to the control panel mount, wherein the control panel mount is to maintain the control panel at a substantially constant viewing angle as the lid assembly is moved between the closed position and the open position.

10. The printing device of claim 9, further comprising:
a cable extending from the control panel to an interior of the chassis along the first link.

11. The printing device of claim 8, further comprising:
a movable cover provided on the chassis, wherein the movable cover is positioned beneath the lid assembly and wherein the movable cover is movable from a closed position to an open position when the lid assembly is in the open position.

12. The printing device of claim 8, further comprising:
a damper at a connection between the first link and the second link, wherein the damper is to dampen rotation between the first link and the second link.

13. The printing device of claim 8, further comprising:
a bracket attached to the movable lid, the bracket having a groove; and
wherein the second link includes a pin inserted in the groove and wherein the pin is to move linearly along the groove during movement of the lid assembly between the first and second positions.

14. A movable control panel system comprising:
a first link rotatably attached to a chassis of a printing device at a proximal end of the first link;
a second link that is:
rotatably attached to the first link at a distal end of the first link; and
movably mounted to a lid assembly of the printing device; and
a control panel mount attached to the second link, wherein the control panel mount is to maintain a substantially constant angle during movement of the lid assembly with respect to the chassis.

15. The movable control panel system of claim 14, further comprising:
a damper at a connection between the first link and the second link, wherein the damper is to dampen rotation between the first link and the second link.
